(19) United States
(12) Patent Application Publication
(10) Pub. No.: US 2011/0317395 A1
(43) Pub. Date: Dec. 29, 2011

(54) OPTICAL SYSTEM FOR LIQUID CRYSTAL ON SILICON PROJECTOR

(75) Inventor: JEN-TSORNG CHANG, Tu-Cheng (TW)

(73) Assignee: HON HAI PRECISION INDUSTRY CO., LTD., Tu-Cheng (TW)

(21) Appl. No.: 12/894,164

(22) Filed: Sep. 30, 2010

(30) Foreign Application Priority Data
Jun. 25, 2010 (CN) 201010209402.4

(51) Int. Cl. F21V 9/14

(52) U.S. Cl. 362/19

(57) ABSTRACT

An optical system for a liquid crystal on silicon (LCoS) projector includes a light emitting diode (LED) array, a light guide plate (LGP), and a polarization cube beam splitter (PBS). The LED array emits a beam of light. The LGP and the PBS are arranged along the optical path of the beam of light. The LGP includes an incident surface directly facing the LED array, an emitting surface, and an array of microstructures formed on the emitting surface. The PBS includes a side surface directly facing the emitting surface and an array of collimator lenses formed on the side surface. The microstructures are positioned at a focal surface of the collimator lenses.

### BACKGROUND

1. Technical Field

The present disclosure relates to projection optical systems and, particularly, to an optical system of a liquid crystal on silicon (LCoS) projector.

2. Description of Related Art

Generally, fly-eye lenses are widely used as diffusers in projectors for diffusing and homogenizing light beams emitted from halogen lamps. However, more and more projectors employ light emitting diodes (LEDs) instead of halogen lamps as light sources. The light beams of the LEDs are more concentrated than those of the halogen lamps. Thus, the fly-eye lenses cannot efficiently diffuse and homogenize the light beams from the LEDs, degrading image quality of the projectors.

Therefore, it is desirable to provide a projection optical system which can ameliorate the above-mentioned limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is an isometric, schematic view of an optical system of an LCoS projector, according to an embodiment.

FIG. 2 is a planar, schematic view of the optical system of FIG. 1.

### DETAILED DESCRIPTION

Embodiments of the present disclosure will now be described in detail with reference to the drawings.

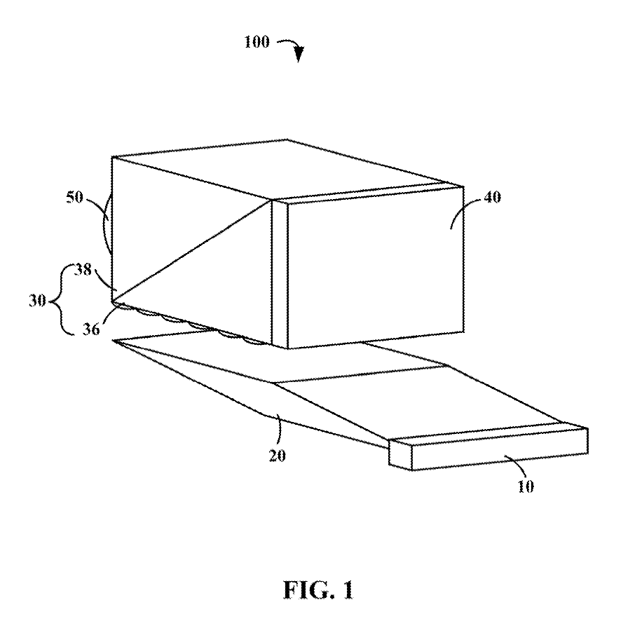

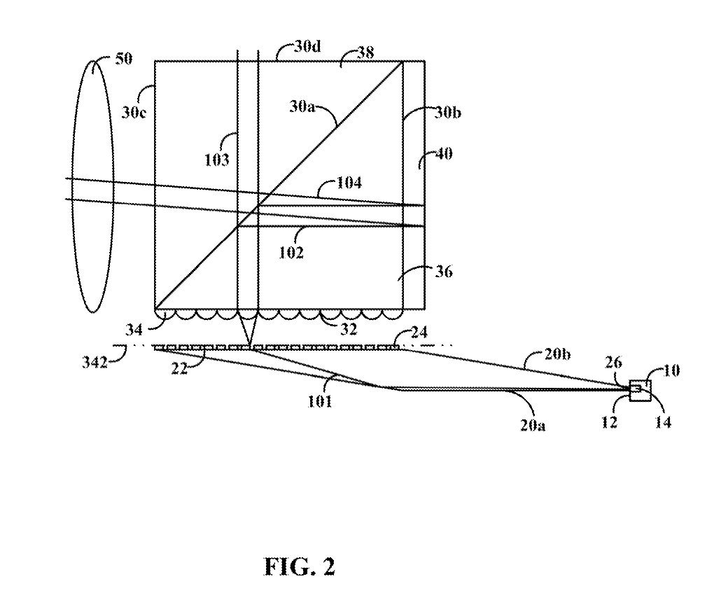

Referring to FIGS. 1 and 2, an optical system 100 for use in an LCoS projector, according to an embodiment, includes an LED array 10, a light guide plate (LGP) 20, a polarization cube beam splitter (PBS) 30, an LCoS panel 40, and a projection lens 50. The LED array 10 is configured for emitting a beam of light 101. The LGP 20 is configured for directing the beam of light 101 to the PBS 30. The PBS 30 is configured for separating the beam of light 101 into a beam of s-polarized light 102 and a beam of p-polarized light 103, reflecting the beam of s-polarized light 102, and transmitting the beam of p-polarized light 103. The LCoS panel 40 is configured for receiving the beam of s-polarized light 102, modulating the beam of s-polarized light 102 into a beam of p-polarized signal light 104 according to input video signal, and reflecting the beam of p-polarized signal light 104. The PBS 30 is also configured for directing the beam of p-polarized signal light 104 to the projection lens 50. The projection lens 50 is configured for projecting the beam of p-polarized signal light onto a screen.

In particular, the LED array 10 includes a silicon substrate that is substantially a rectangular chamber. The LED array 10 includes a front surface 12 and a line of LEDs 14 formed in the front surface 12.

The LGP 20 is substantially a parallelepiped and includes a base surface 20a, an emitting surface 22 opposite to the base surface 20a, and a sloping surface 22b connecting the emitting surface 22 to the base surface 20a. The LGP 20 defines a bevel at an intersection between the sloping surface 22b and the base surface 22a, forming an incident surface 26. The outer surface of the LGP 20 is coated with a high reflective film (not shown). The LGP 20 forms an array of diffusing microstructures 24 on the emitting surface 22. The microstructures 24 can be raised or lowered structures. In this embodiment, the microstructures 24 are raised blocks.

The PBS 30 includes two triangular prisms 36 and 38. The prism 36 has a side surface 32 having the same shape and size as the emitting surface 22. The prism 36 forms an array of collimator lenses 34 on the side surface 32. The size of each collimator lens 34 is larger than that of each microstructure 24. The density of the collimator lenses 34 is smaller than that of the microstructures 34. The prisms 36 and 38 are combined, forming a polarization surface 30a. The polarization surface 30a is at an angle of about 45 degrees with respect to the side surface 32 and is coated with a polarization film which is capable of separating light incident thereon into s-polarized light and p-polarized light, reflecting the s-polarized light, and transmitting the p-polarized light.

In assembly, the LED array 10 is attached to the LGP 20 and the incident surface 26 seals the line of LEDs 14. The PBS 30 is positioned above the LGP 20 such that the emitting surface 22 is aligned with the side surface 32 and the microstructures 24 align in a focal plane of the collimator lenses 32. The LCoS panel 40 is attached to another side surface of the prism 36 (i.e., the side surface connecting the polarization surface 30a and the side surface 32). The projection lens 50 is aligned with a side surface of the prism 38 opposite to the LCoS panel 40.

In operation, the beam of light 101 is generated by the LEDs 14 and enters into the LGP 20. Then, the beam of light 101 can be reflected by the reflective film of the LGP 20 multiple times for preliminary diffusion, and finally approaches the emitting surface 22. Next, the beam of light 101 is dispersed by the closely spaced microstructures 24 and then is collimated by the collimator lenses 34. Thereby, the beam of light 101 is efficiently diffused and homogenized. Then, the beam of light 101 is separated into the beam of s-polarized light 102 and the beam of p-polarized light 103 at the polarization surface 30a. The beam of p-polarized light 103 directly passes the polarization surface 30a and emits from the optical system 100. The beam of s-polarized light 102 is reflected to the LCoS panel 40 and is modulated according to the video input into the beam of p-polarized signal light 104. The beam of p-polarized signal light 104 is directed to the projection lens 50 and projected onto a screen to form an image.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. An optical system for a liquid crystal on silicon (LCoS) projector, comprising:
a light emitting diode (LED) array;
a light guide plate (LGP) comprising an incident surface, an emitting surface, the incident surface aligned with the light emitting diode array;
a polarization cube beam splitter (PBS) comprising a first side surface, a second side surface, a third surface and a polarization surface, the first side surface, the second side surface and the polarization surface forming a triangle, the first side surface aligned with the emitting surface, the polarization surface positioned at an angle of about 45 degrees with respect to the first side surface, the third side surface opposing to the second side surface;
an LCoS panel positioned on the second side surface, and a projection lens aligned with the third side surface.

2. The optical system of claim 1, wherein the LGP comprises an array of microstructures positioned on the emitting surface, the PBS comprises an array of collimator lenses positioned on the first side surface, a size of each collimator lens is larger than that of each microstructure, and a density of the array of collimator lenses is smaller than that of the array of microstructures.

3. The optical system of claim 2, wherein the microstructures are raised structures.

4. The optical system of claim 1, wherein the microstructures are lowered structures.

5. The optical system of claim 2, wherein the microstructures are raised blocks.

6. The optical system of claim 2, wherein the microstructures are positioned at a focal surface of the collimator lenses.

7. The optical system of claim 1, wherein the first side surface has the same shape and size as the emitting surface.

8. The optical system of claim 1, wherein the PBS comprises a first triangular prism and a second triangular prism, the first triangular prism has the first side surface and the second side surface, the second triangular prism has the third side surface, the first and second prisms are combined together to form the polarization surface.

9. The optical system of claim 1, wherein the LED array comprises a front surface and a line of LEDs positioned on the front surface, the incident surface seals the line of LEDs.

10. The optical system of claim 1, wherein the LGP is a parallelepiped and comprises a base surface opposite to the emitting surface and a sloping surface connecting the emitting surface and the base surface, the LGP defines a bevel in an intersection of the base surface and the sloping surface, forming the incident surface.

11. An optical system for an LCoS projector, comprising:
a LED array for emitting a beam of light; and
a LGP comprising an incident surface directly facing the LED array, an emitting surface, and an array of microstructures positioned on the emitting surface; and
a PBS comprising a first side surface directly facing the emitting surface and an array of collimator lenses positioned on the first side surface;
wherein the LGP and the PBS are arranged along the optical path of the beam of light, the microstructures are positioned at a focal surface of the collimator lenses.

12. The optical system of claim 11, wherein the LED array comprises a front surface and a line of LEDs on the front surface; and the incident surface seals the line of LEDs.

13. The optical system of claim 11, wherein the LGP is a parallelepiped and comprises a base surface opposite to the emitting surface and a sloping surface connecting the emitting surface and the base surface, and the LGP defines a bevel in an intersection of the base surface and the sloping surface, forming the incident surface.

14. The optical system of claim 11, wherein a size of each collimator lens is larger than that of each microstructure; and a density of the array of collimator lenses is smaller than that of the array of microstructures

15. The optical system of claim 11, wherein the microstructures are raised or lowered structures.

16. The optical system of claim 11, wherein the microstructures are raised blocks.

17. The optical system of claim 11, wherein the first side surface has the same shape and size as the emitting surface.

18. The optical system of claim 11, wherein the PBS comprises two triangular prisms combined together, forming a polarization surface therebetween, the polarization surface is positioned at an angle of about 45 degrees with respect to the first side surface and is coated with a polarization film for separating light incident thereon into p-polarized light and s-polarized light, transmitting the p-polarized light, and reflecting the s-polarized light.

19. The optical system of claim 18, further comprising an LCoS panel, wherein the LCoS panel is attached to a second side surface of the PBS connecting the first side surface and the polarization surface.

20. The optical system of claim 19, further comprising a projection lens aligned with a third side of the PBS opposite to the LCoS panel.
